(19) United States
(12) Patent Application Publication
(10) Pub. No.: US 2011/0250288 A1
(43) Pub. Date: Oct. 13, 2011

(54) FUNGICIDAL COMPOSITIONS AND METHODS OF ENHANCING TURFGRASS

(75) Inventors: Braden Surrena, Cleveland, TN (US); Christopher Cody, Valdosta, GA (US); Kurt Schwartau, Davis, CA (US); Robert Yarborough, Naples, FL (US)

(73) Assignee: SIPCAM ARGO USA, INC., Durham, NC (US)

(21) Appl. No.: 12/751,742

(22) Filed: Mar. 31, 2010

(51) Int. Cl. A01N 37/34; A01N 57/12; A01P 3/00; A01N 59/26

(52) U.S. Cl. 424/601; 514/525; 514/119

(57) ABSTRACT

The present disclosure provides fungicidal compositions and methods of enhancing vegetation, e.g. turfgrass. The composition may be a combination of chlorothalonil and malachite green dye. Malachite green oxalate is preferred. This composition is mixed with water and inert ingredients such as surfactants and other inert ingredients. A phonosphonate compound may be added, such as a phosphite. Potassium phosphite may be used. Urea phosphite is preferred. The composition is mixed in water with inert ingredients such as surfactants and other inert ingredients.

### CROSS-REFERENCE TO RELATED APPLICATION

This application claims priority to co-pending U.S. Provisional Patent Application entitled, FUNGICIDAL COMPOSITIONS AND METHODS OF ENHANCING TURFGRASS, having Ser. No. 61/165,465 filed Mar. 31, 2009 which is entirely incorporated herein by reference.

The present disclosure relates to fungicidal compositions and methods of using these compositions for the protection and enhancement of turfgrass.

### FIELD OF THE INVENTION

### Background

Highly maintained turfgrasses, such as those found in lawns, golf courses, nursery crops, and other landscaping applications, may develop a variety of diseases, including those related to fungi, and the like. High quality, healthy turfgrass is especially necessary in the golfing industry.

One method of disease control is by reducing the fungi pathogen population on turfgrass by applying fungicides which kill the fungus or prevent the fungus from growing. Turfgrass fungicides may be divided into two broad categories: Contact fungicides and systemic fungicides.

Contact fungicides are generally applied to the leaf and stem surfaces of turfgrasses. These fungicides do not move appreciably within the plants and are thus easily removed by washing or mowing the leaf and stem surfaces. Contact fungicides may only be effective for a short duration, e.g. 7 to 14 days, and do not protect new foliage. Generally, these fungicides are used for control of foliar diseases rather than diseases of the roots and crowns. Typically, contact fungicides have broad spectrum control.

In contrast to contact fungicides, systemic fungicides are absorbed and translocated within the plant. Accordingly, they are not as likely to be removed by mowing or washing. Systemic fungicides may protect plants for a period of 2 to 4 weeks, as well as protect new growth. Many systemic fungicides control both foliar diseases and diseases of the root and crown. Amongst systemic fungicides are those which contain phosphite.

In the 1970s, phosphite containing compositions were screened for fungicidal activity and found to be effective in controlling disease caused by a group of fungi known as oomycetes, e.g. Phytophthora, Plasmopara, Pythium. By the mid 1990s, phosphite products entered the turfgrass market for use as fungicides and fertilizers.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Ratios, concentrations, amounts, and other numerical data may be expressed herein in a range format. Such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. For illustration purposes only, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method may be carried out in the order of events recited or in any other order that is logically possible.

Embodiments of the present disclosure will employ, unless otherwise indicated, techniques of organic chemistry, agrochemistry, pesticide chemistry, and the like, which are within the skill of the art. Such techniques are explained fully in the literature.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. Further, documents or references cited in this text, in a Reference List before the claims, or in the text itself; and each of these documents or references (“herein cited references”), as well as each document or reference cited in each of the herein-cited references (including any manufacturer's specifications, instructions, etc.) are hereby expressly incorporated herein by reference.

Prior to describing the various embodiments, the following definitions are provided and should be used unless otherwise indicated.

### I. DEFINITIONS

Unless otherwise defined, all technical and scientific terms used herein have the same meaning as commonly understood by one of ordinary skill in the art of molecular biology. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the terms “lower alkyl” and “lower alkoxy” refer to alkyl groups of from 1 to 6 carbon atoms and alkoxy groups of from 1 to 6 carbon atoms.

As used herein, the term “systemic fungicide” refers to a fungicide which is absorbed by the plant applied to.

As used herein, the term “contact fungicide” refers to a fungicide which kills fungi by direct contact.

As used herein, the term “phosphonate” refers to a product comprising the salts or esters of phosphorous acid. Phosphorous acid is a commercially available solid which, when mixed with water, forms a strong acid called phosphonic acid. Phosphonic acid is too strong to be used on plants and must be combined with other chemicals to raise pH and decrease potential for plant injury. One means of raising pH is neutralizing phosphonic acid with an alkali salt, including but not limited to potassium hydroxide.

As used herein, “phosphite” refers to alkali metal salts of phosphorous acid.

As used herein, “potassium phosphite” refers to the products resulting from the neutralization of phosphonic acid with potassium hydroxide.

As used herein, “phosphonic acid” refers to an acid produced by dissolving phosphorous acid in water. Phosphonic acid is often used synonymously with phosphorous acid.

As used herein, the term “chlorothalonil” refers to

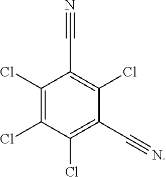

Examples of products containing chlorothalonil are sold under the trade names, BravoR, EchoR, and Daconil. R

As used herein, the term “chloroneb” refers to

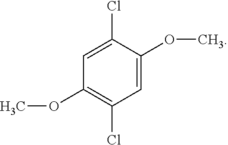

As used herein, the term “cycloheximide” refers to

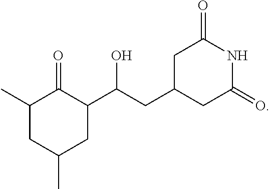

As used herein, the term “mancozeb” refers to

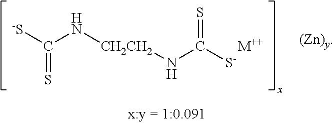

### III. EMBODIMENTS OF THE PRESENT DISCLOSURE

The present disclosure provides fungicidal compositions and methods of enhancing vegetation, e.g. turfgrass. One embodiment of this invention provides a fungicidal composition comprising chlorothalonil and a malachite green dye as described below.

Another embodiment of the present disclosure provides a fungicidal composition comprising: a chlorothalonil, one or more phosphonate compounds, and a malachite green dye.

The fungicide of the present disclosure may be non-systemic and includes, but is not limited to, anilazine, chlorothalonil, chloroneb, cycloheximide, and mancozeb. Chlorothalonil is the preferred fungicide.

In an embodiment, a phosphonate compound of the present disclosure may be a phosphite including, but not limited to, calcium phosphite, potassium phosphite, magnesium phosphite, urea phosphite and phosphonic acid. Urea phosphite is the preferred phosphonate. The term “phosphonate” as used in the claims means any of the compounds listed in the preceding sentence.

In an embodiment, a dye of the present disclosure may be a malachite green dye, including, but not limited to, malachite green monoxalate (CAS No. 18015-76-4), malachite green chloride oxalate (e.g. CAS No. 129-72-6), leucomalachite green (CAS No. 129-73-7), malachite green carbinol (CAS No. 510-13-4), malachite green (CAS No. 569-64-2), brilliant green (CAS No. 633-03-4), malachite green oxalate (CAS No. 2437-29-8), malachite green cation (CAS No. 10309-95-2), malachite green hydrogen sulfate (CAS No. 16044-24-9), malachite green monooxalate (CAS No. 18015-76-4), malachite green acetate (CAS No. 41272-40-6), malachite green phosphotungstomolydate (CAS No. 61725-50-6), malachite green phosphomolybdate (CAS No. 68083-41-0), malachite green phosphotungstate (CAS No. 68132-90-1), malachite green benzoate (CAS No. 68527-61-7), malachite green phosphomolybdate (CAS No. 68814-05-1), and malachite green carbinol hydrochloride (CAS No. 123333-61-9).

In one embodiment, the present disclosure provides a fungicidal composition comprising chlorothalonil and a malachite green dye, e.g. malachite green oxalate (CAS No. 18015-76-4. The combination of the chlorothalonil and green malachite green dye may be present in an amount of the combination by weight of from 90% to 99.9% and the malachite green dye in an amount from 0.1% to 10%. Preferably the combination has from 95% to 99.6% of chlorothalonil and from 0.4% to 5% malachite green dye. Malachite green oxalate is preferred. This combination is mixed with water containing surfactants and inert ingredients to make a suitable liquid mixture to apply to plants. The surfactants and inert ingredients can compose 3% to 20% by weight of the combination when mixed with water.

In an embodiment, the present disclosure provides a fungicidal composition comprising chlorothalonil, a phosphonate, e.g. urea or potassium phosphite, and a malachite green dye, e.g. malachite green monooxalate (CAS No. 18015-76-4). Urea phosphite is preferred.

The chlorothalonil can be present in the fungicide in an amount based upon dry weight between 30 and 90%, with malachite green oxalate present in an amount from 0.2% to 5% and the phosphonate present in an amount from 2 to 40%. It is preferred that the chlorothalonil be present in an amount between 40% and 70%, malachite green oxalate present in an amount from 0.3% and 1% and the phosphonate present in an amount from 15% to 30%. It is more preferable that the chlorothalonil be present in an amount from 55% to 65%, with malachite green oxalate present in an amount from 0.3% and 0.5% and the phosphonate present in an amount from 15% to 25% by weight.

In an embodiment, the present disclosure provides fungicidal compositions in which the non-systemic fungicide accounts for about 40% to about 90%; about 40% to about 50%; about 50% to about 60%; about 60% to about 70%; about 70% to about 80%; or about 80% to about 90% of the composition.

In an embodiment, the fungicidal compositions of the present disclosure may include additional known fungicidal agents including, but not limited to, acibenzolar-5-methyl, azoxystrobin, benalaxyl, benomyl, blasticidin-S, bromuconazole, captafol, captan, carbendazim, carboxin, carpropamide, chlorothalonil, fungicidal compositions based on copper, derivatives of copper such as copper hydroxide and copper oxychloride, cyazofamide, cymoxanil, cyproconazole, cyprodinil, dichloran, diclocymet, diethofencarb, difenoconazole, diflumetorim, dimethomorph, diniconazole, discostrobin, dodemorph, dodine, edifenphos, epoxyconazole, ethaboxam, ethirimol, famoxadone, fenamidone, fenarimol, fenbuconazole, fenhexamide, fenpiclonil, fenpropidine, fenpropimorph, ferimzone, fluazinam, fludioxonil, flumetover, fluquinconazole, flusilazole, flusulphamide, flutolanil, flutriafol, folpel, furalaxyl, furametpyr, guazatine, hexaconazole, hymexazol, imazalil, iprobenphos, iprodione, isoprothiolane, kasugamycin, kresoxim-methyl, mancozeb, maneb, mefenoxam, mepanipyrim, metalaxyl and their enantiomeric forms such as metalaxyl-M, metconazole, metiram-zinc, metominostrobin, oxadixyl, pefurazoate, penconazole, pencycuron, phtalide, picoxystrobin, probenazole, prochloraz, procymidone, propamocarb, propiconazole, pyraclostrobin, pyrimethanil, pyroquilon, quinoxyfen, silthiofam, simeconazole, spiroxamine, tebuconazole, tetraconazole, thiabendazole, thifluzamide, thiophanate, for example thiophanate-methyl, thiram, triadimefon, triadimenol, tricyclazole, tridemorph, trifloxystrobin, triticonazole, derivatives of valinamide such as for example, iprovalicarb, vinclozolin, zineb, and zoxamide.

In an embodiment, the fungicidal compositions according to the present disclosure may be used alone or as formulations comprising one or more other compatible components including, but not limited to, solid or liquid fillers or diluents, adjuvants, surfactants or equivalents, which are suitable for the desired use and which are acceptable for uses in agriculture. These formulations may be of any type known in the sector which are suitable for application onto all types of plantations or crops. These formulations may be prepared in any manner known in this sector, also form part of the present disclosure. These formulations may also contain ingredients, such as protective colloids, adhesives, thickeners, thixotropic agents, penetrating agents, oils for spraying, stabilizers, preserving agents (in particular moldproofing agents), and sequestering agents, as well as other known active ingredients which have pesticidal properties (in particular fungicidal, insecticidal, acaricidal or nematicidal properties) or which have plant-growth-regulating properties.

In an embodiment the formulations of the present disclosure may be created by combining fungicidal compositions of the present disclosure with any solid or liquid additives corresponding to the usual formulation techniques. Accordingly, formulations according to the present disclosure may contain from about 0.05% to about 99% (by weight) of one or more fungicidal compositions of the present disclosure, from about 1% to about 95% of one or more solid or liquid fillers and, optionally, from about 0.1% to about 50% of one or more other compatible compounds, such as surfactants and the like. In the present account, the term “filler” means an organic or inorganic, natural or synthetic component with which the active components are combined to facilitate its application, for example, onto the plants, the seeds or the soil. This filler is generally inert and it must be acceptable for agronomic uses, in particular for treating plants, vegetation, seeds, soil, and the like.

In an embodiment, the filler of formulations of the present disclosure may be solid, for example clays, natural or synthetic silicates, silica, resins, waxes, solid fertilizers (for example ammonium salts), natural soil minerals, such as kaolins, clays, talc, lime, quartz, attapulgite, montmorillonite, bentonite or diatomaceous earths, or synthetic minerals, such as silica, alumina or silicates, in particular aluminium or magnesium silicates. These solid fillers which are suitable for granules are as follows: natural, crushed or broken rocks, such as calcites, marble, pumice, sepiolite or dolomite; synthetic granules of inorganic or organic flours; granules of organic material such as sawdust, coconut shell, corn ear or envelope, or tobacco stem; kieselguhr, tricalcium phosphate, powdered cork or adsorbent carbon black; water-soluble polymers, resins, waxes; or solid fertilizers. Such compositions may, if so desired, contain one or more compatible agents such as wetting agents, dispersing agents, emulsifiers or dyes which, when they are solid, can also act as diluents.

In an embodiment, the fillers of formulations of the present disclosure may also be liquids, for example: water, alcohols, in particular butanol or glycol, as well as ethers or esters thereof, in particular methyl glycol acetate; ketones, in particular acetone, cyclohexanone, methyl ethyl ketone, methyl isobutyl ketone or isophorone; petroleum fractions such as paraffinic or aromatic hydrocarbons, in particular xylenes or alkylnaphthalenes; mineral or plant oils; aliphatic chlorohydrocarbons, in particular trichloroethane or methylene chloride; aromatic chlorohydrocarbons, in particular chlorobenzenes; water-soluble or highly polar solvents such as dimethylformamide, dimethyl sulphoxide, N,N-dimethylacetamide or N-methylpyrrolidone; N-octylpyrrolidone, liquefied gases; or the like, whether taken separately or as a mixture.

In an embodiment, the surfactant of the formulations of the present disclosure may be an emulsifier, a dispersing agent or a wetting agent, of ionic or nonionic type or a mixture of these surfactants. Examples of surfactants include, but are not limited to, polyacrylic acid salts, lignosulphonic acid salts, phenolsulphonic or naphthalenesulphonic acid salts, polycondensates of ethylene oxide with fatty alcohols or fatty acids or fatty esters or fatty amines, substituted phenols (in particular alkylphenols or arylphenols), ester-salts of sulphosuccinic acid, taurine derivatives (in particular alkyl taurates), phosphoric esters of alcohols or of polycondensates of ethylene oxide with phenols, fatty acid esters with polyols, or sulphate, sulphonate or phosphate functional derivatives of the compounds described above. At least one surfactant is generally essential when the active materials and/or the inert filler are insoluble or only sparingly soluble in water and when the filler for the said composition to be applied is water.

In an embodiment, formulations according to the present disclosure may also contain other additives such as adhesives or dyes. Adhesives such as carboxy-methylcellulose, or natural or synthetic polymers in the form of powders, granules or matrices, such as gum arabic, latex, polyvinylpyrrolidone, polyvinyl alcohol or polyvinyl acetate, natural phospholipids, such as cephalins or lecithins, or synthetic phospholipids can be used in the formulations. It is possible to use dyes such as inorganic pigments, such as, for example: iron oxides, titanium oxides, Prussian blue; organic dyestuffs, such as alizarin or of trace elements such as iron, manganese, boron, copper, cobalt, molybdenum or zinc salts.

In an embodiment, the formulations containing the fungicidal compositions of the present disclosure, which are used to combat the phytopathogenic fungi of crops, may also contain stabilizers, other fungicidal agents, insecticides, acaricides, nematicides, anti-helminths or anti-coccidoses, bactericides, attractant or repellent agents or pheromones for arthropods or vertebrates, deodorizers, flavourings or dyes, which may be chosen for the purpose of improving the strength, the persistence, the safety, the spectrum of action on the phytopathogenic fungi of crops or to make the composition capable of accomplishing other useful functions for the areas treated. For their agricultural use, the fungicidal compositions according to the present disclosure are consequently formulated in various solid or liquid forms.

In an embodiment, solid formulations of the fungicidal compositions of the present disclosure include, but are not limited to, powders for dusting (with an active material content which can be up to 100%) and granules, including those obtained by extrusion, by atomization, by compacting, by impregnation of a granulated support or by granulation from a powder (the active material content in these granules being between 0.5 and 80% for the latter cases).

In an embodiment, liquid formulations or formulations containing fungicidal compositions of the present disclosure are liquid compositions when applied, such as water-soluble concentrates, emulsifiable concentrates, emulsions, concentrated suspensions and wettable powders (or powders for spraying).

In an embodiment, concentrated suspensions including the fungicidal compositions of the present disclosure, which can be applied by spraying, are prepared so as to obtain a stable fluid product which does not become deposited and which gives good bioavailability of the active material(s). These suspensions usually contain from about 5% to about 75% of active materials, from about 10% to about 25%, from about 0.5% to about 75% of surfactants, and from about 5% to about 50%, from about 0% to about 10% of suitable additives, such as thickeners of organic or mineral origin, antifoaming agents, corrosion inhibitors, adhesives, preserving agents, such as, for example, Proxel GXL®, antifreezes and, as support, water or an organic liquid in which the active materials are insoluble or sparingly soluble: certain organic solid materials or mineral salts may be dissolved in the support to help prevent sedimentation or as antifreezes for the water. In certain cases, and in particular for formulations intended for treating seeds, one or more dyes may be added. For foliar applications, the choice of surfactants is paramount for obtaining good bioavailability of the active material(s); thus, a combination of a surfactant of hydrophilic nature (HLB>10) and a surfactant of lipophilic nature (HLB<5) may be used.

In an embodiment, the fungicidal compositions may be used as, but not limited to, sprays, powders, granules, mists, foams, emulsions, and the like.

An embodiment of the present disclosure provides a method of protecting and/or enhancing vegetation, such as turfgrass, comprising applying a fungicidal composition of the present disclosure to plants, soil, or seeds which are infected with fungal pathogens or predisposed to fungal pathogen infection. The effective working doses of the fungicidal compositions of the present disclosure may vary widely depending on the nature of the plant disease, e.g. fungi, to be eliminated, as well as the degree of infestation.

In an embodiment, the fungicidal composition is applied to vegetation by various means including, but not limited to, spraying a liquid comprising a fungicidal composition of the present disclosure onto the aerial parts of vegetation; dusting vegetation using a fungicidal composition of the present disclosure; incorporation of granules or powders comprising fungicidal compositions of the present disclosure into the soil; watering on or around the vegetation with a solution comprising fungicidal compositions of the present disclosure; injection of a fungicidal composition of the present disclosure; painting using a fungicidal composition of the present disclosure; and coating or forming a film on seeds of the vegetation using a solution or mixture comprising the fungicidal comp-ositions of the present disclosure.

In an embodiment, the fungicidal compositions of the present disclosure may be used in treating or controlling plant diseases including, but not limited to, blast (Pyricularia oryzae), Helminthosporium leaf spot (Cochliobolus miyabeanus) and sheath blight (Rhizoctonia solani) of rice; powdery mildew (Erysiphe graminis f. sp. hordei, f. sp. tritici), scab (Gibberella zeae), rust (Puccinia striiformis, P. graminis, P. recondita, P. hordei), snow blight (Typhula sp., Micronectriella nivalis), loose smut (Ustilago tritici, U. nuda), bunt (Tilletia caries), eye spot (Pseudocercosporella herpotrichoides), foot rot (Rhizoctonia cerealis), scald (Rhynchosporium secalis), leaf blight (Septoria tritici) and glume blotch (Leptosphaeria nodorum) of barley, wheat, oats and rye; melanose (Diaporthe citri), scab (Elsinoe fawcetti), penicillium rot (Penicillium digitatum, P. italicum) of citrus; blossom blight (Sclerotinia mali), canker (Valsa mali), powdery mildew (Podosphaera leucotricha), Alternaria leaf spot (Alternaria mali) and scab (Venturia inaequalis) of apple; scab (Venturia nashicola), black spot (Alternaria kikuchiana) and rust (Gymnosporangium haraeanum) of pear; brown rot (Sclerotinia cinerea), scab (Cladosporium carpophilum) and Phomopsis rot (Phomopsis sp.) of peach; downy mildew (Plasmopara viticola), Sphaceloma scab (Elsinoe ampelina), ripe rot (Glomerella cingulata), powdery mildew (Uncinula necator) and rust (Phakopora ampelopsidis) of grape; anthracnose (Gloeosporium kaki) and leaf spot (Cercospora kaki, Mycosphaerella nawae) of Japanese persimmon; cucumber downy mildew (Pseudoperonospora cubensis); anthracnose (Colletotrichum lagenarium), powdery mildew (Sphaerotheca fuliginea) and gummy stem blight (Mycosphaerella melonis) of melons and cucumbers; early blight (Alternaria solani), leaf mold (Cladosporium fulvum) and late blight (Phytophthora infestans) of tomato; brown spot (Phomopsis vexans) and powdery mildew (Erysiphe cichoracearum) of eggplant; leaf spot (Alternaria brassicae) and white spot (Cercosporella brassicae) of vegetables of Cruciferae; onion rust (Puccinia allii); purple stain (Cercospora kikuchii), Sphaceloma scab (Elisinoe glycines) and pod and stem blight (Diaporthe phaseolorum var. sajae) of soybean; kidney bean anthracnose (Colletotrichum lindemthianum); leaf spot (Mycosphaerella personatum) and leaf spot (Cercospora arachidicola) of peanut; powdery mildew (Erysiphe pisi), and downy mildew (Peronospora pisi) of pea; downy mildew (Peronospora viciae) and Phytophthora rot (Phytophthora nicotianae) of broad bean; early blight (Alternaria solani) and late blight (Phytophthora infestans) of potato; powdery mildew (Sphaerotheca humuli) and Phytophthora rot (Phytophthora nicotianae) of strawberry; net blister blight (Exobasidium recticulatum) and white scab (Erysiphe leucospila) of tea plant; brown spot (Alternaria longipes), powdery mildew (Erysiphe cichoracearum), anthracnose (Colletotrichum tabacum) and Phytophthora rot (Phytophthora parasitica) of tobacco; beet leaf spot (Cercospora beticola); black spot (Diplocarpon rosae), powdery mildew (Sphaerotheca pannosa) and Phytophthora rot (Phytophthora megasperma) of rose; leaf spot (Septoria chrysanethemella) and white rust (Puccinia horiana) of chrysanthemum; gray mold (Botrytis cinerea) and stem rot (Sclerotinia sclerotiorum) of fruit trees such as grape and citrus and various crops such as cucumber, tomato, beans and vegetables; and plant diseases caused by Pythium fungi (Pythium sp.).

Among the symptoms observed on individual plants of a turf grass include leaf spots, foliar lesions, stem lesions, foliar blight, foliar dieback, crown rot, and root rot. A leaf spot is a round or oval area on the leaf with a distinct border, which is usually a different color than the center of the spot. A foliar lesion is irregular in shape and is typically larger than a leaf spot, but still has a distinct border that is usually a different color. A stem lesion is very similar to a foliar lesion, but is present on the stem or leaf sheath of the grass plant rather than on the leaves. Foliar blight and foliar dieback produce symptoms on whole leaves or entire plants; the two are distinguished in that a foliar blight produces a distinct border between healthy and diseased turf, whereas a foliar dieback does not. Crown rot is observed as a dark and rotten area at the base of the turfgrass plant. Root rots produce a visibly dark and rotten root system, and also a noticeable reduction in root depth in affected areas. Crown rots and root rots often occur together, and may also include rotting of stolons and rhizomes if present.

Signs are the visible evidence of the presence of a pathogen. Most turfgrass diseases are caused by fungi, and even though fungi are microscopic organisms, some produce larger structures at certain times in their life cycle that can be seen with the naked eye. Mycelium is a cottony or spider-web-like mass of fungal growth that certain fungi produce when the turf is wet or humidity is high. Spore masses are fuzzy or jelly-like growths produced on the diseased tissue by certain fungi, again usually when the turf is wet or humidity is high. Sporophores are enclosed structures that contain fungal spores. If present, sporophores are often seen as small, dark specks on the diseased tissue. Sclerotia are small, round, hard structures produced on the diseased turf or in the thatch layer by certain fungi. Sclerotia are actually survival structures that some fungi use to survive through periods of unfavorable weather conditions. Most people are familiar with mushrooms, which are the large spore-producing structures produced above-ground by Basidiomycete fungi. Some turfgrass pathogens, most notably the fairy ring fungi, produce mushrooms as a sign of their presence.

In an embodiment, the fungicidal compositions of the present disclosure are especially effective in treating or controlling plant diseases in turfgrasses including, but not limited to, dollar spots, summer stress and heat stress. It is thought that the fluorescent characteristic of the malachite green dye may reduce the ultraviolet radiation of the sun which reduces the evaporation of the fungicide. which reduces the turfgrass evapotranspiration and heat stress.

Summer stress syndrome resulting in ornamental turfgrass decline such as but not limited to summer bentgrass decline may be caused by one or more of the following conditions:

a. poor soil conditions;

b. compaction of the soil;

c. poor drainage of the soil;

d. improper particle size or shape;

Additional causes are:

1. poor environment;

2. lack of air movement;

3. lack of morning sun;

4. shade;

5. tree root competition;

6. irrigation;

7. water quality;

8. salt;

9. photo respiration;

In periods of high temperature and high sunlight intensity respiration exceeds the photosynthesis in ornamental turfgrasses such as but not limited to creeping bentgrass. Respiration of ornamental turfgrasses such as but not limited to bentgrass is two to three times greater in light than in darkness. Photorespiration increases with temperature which reflects declines in CO₂ assimilation and photoassimilate production. These conditions may then result in a condition called ornamental turfgrass summer stress or heat stress. This condition is manifested by a general discoloration and decline in ornamental turfgrass quality and turfgrass health.

In an embodiment, the fungicidal compositions of the present disclosure may be applied to all turfgrasses including, but not limited to, cool season turfgrasses and warm season turfgrasses. Examples of cool season turfgrasses include, but are not limited to, Bluegrasses (Poa L.), such as Kentucky Bluegrass (Poa pratensis L.), Rough Bluegrass (Poa trivialis L.), Canada Bluegrass (Poa compressa L.), Annual Bluegrass (Poa annua L.), Upland Bluegrass (Poa glaucantha Gaudin), Wood Bluegrass (Poa nemoralis L.). and Bulbous Bluegrass (Poa bulbosa L.); the Bentgrasses and Redtop (Agrostis L.), such as Creeping Bentgrass (Agrostis palustris Huds.), Colonial Bentgrass (Agrostis tenius Sibth.), Velvet Bentgrass (Agrostis canina L.), South German Mixed Bentgrass (Agrostis L.), and Redtop (Agrostis alba L.); the Fescues (Festuca L.), such as Red Fescue (Festuca rubra L.). Chewings Fescue (Festuca rubra var. commutata Gaud.), Sheep Fescue (Festuca ovina L.), Hard Fescue (Festuca ovina var. duriuscula L. Koch), Hair Fescue (Festuca capillata Lam.). Tall Fescue (Festuca arundinacea Schreb.), Meadow Fescue (Festuca elanor L.); the Ryegrasses (Lolium L.), such as Perennial Ryegrass (Lollium perenne L.), Italian Ryegrass (Lolium multiflorum Lam.); the Wheatgrasses (Agropyron Gaertn.), such as Fairway Wheatgrass (Agropyron cristatum (L.) Gaertn.), Western Wheatgrass (Agropyron smithii Rydb.), Beachgrass (Ammophila Host.), Smooth Brome (Bromus inermis Leyss.), Timothy (Phleum L.). Orchardgrass (Dactylis glomerata L.), Crested Dog's-Tail (Cynosurus cristatus L.). Examples of warm season turfgrasses include, but are not limited to, Bermudagrasses (Cynodon L. C. Rich), Zoysiagrasses (Zoysia Willd.), St. Augustinegrass (Stenotaphrum secundatum (Wait.) Kuntze), Centipedegrass (Eremochioa ophiuroides (Munro.) Hack.), Carpetgrass (Axonopus Beauv.), Bahiagrass (Paspalum notalum Flugge.), Kikuyugrass (Pennisetum clandestinum Hochst. ex Chiov.), Buffalograss (Buchloe dactyloides (Nutt.) Engelm.), Blue Grama (Bouteloua gracilis (H.B.K.) Lag. ex Steud.), and Sideoats Grama (Bouteloua curtipendula (Michx. Torr.).

### EQUIVALENTS

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### Example 1

The compositions set forth in Table 1 were either premixed or tank mixed with water as indicated in the table. This mixture was applied to Bentgrass with the results set forth below.

Summer Stress Syndrome in Bentgrass, 2009

A trial was conducted on creeping bentgrass green at the Hancock Turfgrass Research Center, E. Lansing, Mich. The plot area was initially mowed at 0.150″ using a triplex mower arid gradually reduced to 0.125″ using a walk-behind mower. Fertility was maintained at approximately 0.3 lb. N/1000 ft2?/month with Country Club 18-4-12 fertilizer over the entire study with application dates and rates as follows: 6/5 (¼ lb N/1000 sq ft2?), 6/24 (⅛ lb N/1000 sq ft), 7/7 (⅛ lb N/1000 sq ft), 7/21 (¼ lb N/1000 sq ft), 8/7 (¼ lb N/1000 sq ft). The study was set up in a randomized complete block design with four replications of each treatment. Plots measured 27×6′ with V alleys. Treatments were applied at 42 PSI in a 48 GPA spray volume using a CO₂ backpack sprayer and a/single 8002E Tee-Jet flat fan nozzle. Initial treatment applications were made on June 10. All treatments were reapplied on 6/23, 7/13, 7/21, 8/7, and 8/19. Quality ratings, which were a combination of turfgrass color and density, were visually estimated using a 1 to 10 scale, where 1=poor, 7=acceptable, and 10=excellent. All data were analyzed using a statistical of variance (ANOVA) and means separated by the least significant digit (LSD)(p=0.05).

As shown in Table I below, several treatments and treatment combinations performed reasonably well in this test. Most of the treatments provided statistically significant improvement in turfgrass quality compared to the untreated control which had an average maximum quality rating of 5.8 in early July and a low of 4.8 in early August (Table 1). Phyte-Off exhibited good turf quality. No phototoxicity was observed in any of the treated plots during this study.

The compositions of this invention, numbers 7, 6, 3 and 1 in Table 1, performed well throughout the entire test period and offer significant cost savings over some of good performing compositions. The compositions of this invention stimulate the production of critical plant components, which improve summer stress tolerance. These compositions enhances turf quality factors such as color, strength, density and consistency, while controlling dollar spot, brown patch, leaf spot, gray leaf spot, anthracnose and other turf diseases. It also controls numerous ornamental pathogens.

The compositions of this invention allow a two to three week spray interval which reduces the costs of fungus control. These compositions perform well on greens and tees of golf courses and ornamentals grasses and shrubbery.

The compositions of this invention adhere to the plants very well. It controls more than seventy-five turf and ornamental diseases.

TABLE 1
Simpcam Agro summer stress on creeping bentgrass putting green, 2009

| | | | | | Rating Date | | | | | |
|---|---|---|---|---|---|---|---|---|---|---|
| Trt | Treatment | | Rate | Application | Jul. 2, 2009 | | Jul. 16, 2009 | | Jul. 29, 2009 | |
| No. | Name | Rate | Unit | Interval | Mean^{a} | LSD^{b} | Mean | LSD | Mean | LSD |
| 7 | Chlorothalonil 720 g/lt + | 7 | fl oz/1000 | 14 days | 6.3 | bcd | 6.3 | c-f | 7.0 | bcd |
| | green oxalate dye + | | ft² | | | | | | | |
| | K phosphite | | | | | | | | | |
| 6 | Chlorothalonil 82.5% + | 3.25 | oz/1000 | 14 days | 6.5 | bcd | 6.8 | a-d | 7.0 | bcd |
| | green oxalate dye | | ft² | | | | | | | |
| 8 | Phyte-Off ® | 2 | fl oz/1000 | 14 days | | | | | | |
| | | | ft² | | | | | | | |
| 3 | Chlorothalonil 720 g/lt + | 3.6 | fl oz/1000 | 14 days | 6.5 | bcd | 6.3 | c-f | 6.3 | d |
| | green oxalate dye | | ft² | | | | | | | |
| 1 | Chlorothalonil 720 g/lt + | 3.6 | fl oz/1000 | 14 days | 6.5 | bcd | 6.0 | d-g | 6.3 | d |
| | green oxalate dye | | ft² | | | | | | | |
| 4 | Phyte-Off ® | 2 | fl oz/1000 | 14 days | | | | | | |
| | | | ft² | | | | | | | |
| 5 | Chlorothalonil 720 g/lt | 3.6 | fl oz/1000 | 14 days | 5.5 | d | 5.5 | fg | 6.3 | d |
| | no dye | | ft² | | | | | | | |
| 15 | Untreated Control | | | | 5.8 | cd | 5.5 | fg | 5.0 | e |
| | | | | | Rating Date | | | | | |
| Trt | Treatment | | Rate | Application | Aug. 4, 2009 | | Aug. 14, 2009 | | Aug. 24, 2009 | |
| No. | Name | Rate | Unit | Interval | Mean | LSD | Mean | LSD | Mean | LSD |
| 7 | Chlorothalonil 720 g/lt + | 7 | fl oz/1000 | 14 days | 7.0 | a-d | 7.3 | abc | 7.3 | b |
| | green oxalate dye + | | ft² | | | | | | | |
| | K phosphite | | | | | | | | | |
| 6 | Chlorothalonil 82.5% + | 3.25 | oz/1000 | 14 days | 7.0 | a-d | 7.0 | bcd | 6.8 | bcd |
| | green oxalate dye | | ft² | | | | | | | |
| 8 | Phyte-Off ® | 2 | fl oz/1000 | 14 days | | | | | | |
| | | | ft² | | | | | | | |
| 3 | Chlorothalonil 720 g/lt + | 3.6 | fl oz/1000 | 14 days | 6.3 | d | 6.5 | cde | 6.8 | bcd |
| | green oxalate dye | | ft² | | | | | | | |
| 1 | Chlorothalonil 720 g/lt + | 3.6 | fl oz/1000 | 14 days | 6.3 | d | 6.0 | e | 6.3 | cd |
| | green oxalate dye | | ft² | | | | | | | |
| 4 | Phyte-Off ® | 2 | fl oz/1000 | 14 days | | | | | | |
| | | | ft² | | | | | | | |
| 5 | Chlorothalonil 720 g/lt | 3.6 | fl oz/1000 | 14 days | 6.3 | d | 6.0 | e | 6.0 | de |
| | no dye | | ft² | | | | | | | |
| 15 | Untreated Control | | | | 4.8 | e | 5.0 | f | 5.3 | ef |

^{a}Mean of 4 replications.
^{b}Means followed by same letter do not significantly differ (P = .05, LSD)
Phyte-Off ® is Sipcam Agro USA, Inc. brand of potassium phosphite. The chlorothalonil green oxalate dye is technically chlorothalonil and malachite green monoxalate.
Location: Hancock Turfgrass Research Center, East Lansing, MI.
Rating Type: Turfgrass Quality.
Rating Scale: 1-10, where 1 = poor, 7 = acceptable, and 10 = excellent.

We claim:

1. A fungicidal composition in water comprising a mixture of:
(a) chlorothalonil; and
(b) malachite green dye.

2. The fungicidal composition of claim 1 which also contains a phosphonate.

3. The fungicidal composition of claim 2 in which the phosphonate is a phosphite.

4. The fungicidal composition of claim 3 in which the phosphite is urea phosphite.

5. The fungicidal composition of claim 1 in which the malachite green dye is malachite green oxalate.

6. The fungicidal composition of claim 1 in which the malachite green dye is malachite green monooxalate.

7. The fungicidal composition of claim 2 in which the malachite green dye is malachite green oxalate.

8. The fungicidal composition of claim 4 in which the malachite green dye is malachite green monooxalate.

9. The fungicidal composition of claim 1 in which the mixture of malachite green dye and chlorothalonil is present in a percentage by dry weight of between 90 to 99.9% of chlorothalonil and from 0.1 to 10% of malachite green dye.

10. The fungicidal composition of claim 1 in which the mixture of malachite green dye and chlorothalonil is present in a percentage by dry weight of between 95 to 99.6% of chlorothalonil and from 0.4 to 5% of malachite green dye.

11. The fungicidal composition of claim 1 in which surfactants and inert ingredients are present in an amount of 3 to 20% by weight of the combination of the fungicidal composition and inert ingredients and the water in they are mixed.

12. A fungicidal composition comprising:
a. chlorothalonil;
b. malachite green dye; and
c. a phosphonate.

13. The fungicidal composition of claim 12 in which the fungicidal composition contains by dry weight from 30 to 90% of chlorothalonil, from 0.2 to 5% malachite green dye, and from 2 to 40% of a phosphonate.

14. The fungicidal composition of claim 12 in which the fungicidal composition contains by dry weight from 40 to 90% of chlorothalonil, from 0.3 to 1% malachite green dye, and from 15 to 30% of a phosphonate.

15. The fungicidal composition of claim 12 in which the fungicidal composition contains by dry weight from 40 to 90% of chlorothalonil, from 0.3 to 1% malachite green dye, and from 15 to 30% of urea phosphite.

16. A method for treating plant diseases comprising applying the fungicidal composition of claim 1 to plants, soil, or seeds in need thereof.

17. A formulation comprising a fungicidal composition according to claim 1 and one or more additives selected from the group consisting of: a surfactant, a filler, an emulsifier, a dispersing agent, a wetting agent, protective colloids, adhesives, thickeners, thixotropic agents, penetrating agents, oils for spraying, stabilizers, preserving agents, and sequestering agents.

18. A method for treating plant diseases comprising applying the formulation of claim 4 to plants, soil, or seeds in need thereof.

19. A method for treating plant diseases comprising applying the formulation of claim 15 to plants, soil, or seeds in need thereof.
